(19) United States
(12) Patent Application Publication
(10) Pub. No.: US 2016/0032711 A1
(43) Pub. Date: Feb. 4, 2016

(54) Methods and Apparatus for Measuring Downhole Position and Velocity

(71) Applicant: Schlumberger Technology Corporation, Sugar Land, TX (US)

(72) Inventors: Todor Sheiretov, Houston, TX (US); Elizabeth Dussan V., Watertown, MA (US); Sarah Blake, Richmond, TX (US); Michael Jensen, Richmond, TX (US); Neil Herbst, Houston, TX (US); Franz Aguirre, Sugar Land, TX (US); Robin Ewan, Stafford, TX (US); Ezequiel Saavedra, Missouri City, TX (US)

(21) Appl. No.: 14/448,818

(22) Filed: Jul. 31, 2014

(51) Int. Cl. E21B 47/09; G01V 11/00

(52) U.S. Cl. CPC E21B 47/09; G01V 11/002

(57) ABSTRACT

An apparatus for measuring at least one of downhole position and velocity. The apparatus includes a body. A roller is connected with the body, and a plurality of sensors is connected with the body. The plurality of sensors can acquire roller data and wellbore data. The roller data and wellbore data can be used to determine at least one of the velocity and position of the apparatus. The apparatus can also have an electronic module that is in communication with the plurality of of sensors.

### CROSS-REFERENCE TO RELATED APPLICATIONS

None.

### FIELD OF THE DISCLOSURE

The disclosure generally relates to methods and apparatus for measuring downhole position and velocity.

### BACKGROUND

Downhole operations often require the accurate placement of a downhole tool at a desired location. The location of downhole tools can be estimated by monitoring a spooling device; however, cable stretch causes such estimates to be inaccurate.

### SUMMARY

An embodiment of an apparatus for measuring at least one of downhole position and velocity includes a body. A roller is connected with the body, and a plurality of sensors is connected with the body. The plurality of sensors acquires roller data and wellbore data. The roller data and wellbore data are used to determine the velocity, position, or both of the apparatus. The apparatus also includes an electronic module. The electronic module is in communication with the set of sensors.

An example method of monitoring an apparatus in a wellbore includes acquiring roller data related to the number of revolutions of a roller connected to a body of an apparatus. The example method also includes acquiring wellbore data related to wellbore properties, transmitting the roller data and wellbore data to a processor. The example method further includes determining at least one of velocity of the apparatus and position of the apparatus in the wellbore.

An example method of monitoring an apparatus in a wellbore includes measuring the number of revolutions of a roller connected with an apparatus, and acquiring wellbore data related to wellbore properties. The method also includes determining the velocity of the apparatus using the wellbore data and the measured number of revolutions.

### BRIEF DESCRIPTION OF THE DRAWINGS

FIG. 1 depicts a schematic of an apparatus located in a wellbore.

FIG. 2 depicts a schematic of an apparatus according to one or more embodiments.

FIG. 3 depicts a schematic of an apparatus according to one or more embodiments.

FIG. 4 depicts a schematic of an apparatus according to one or more embodiments.

FIG. 5 depicts a schematic of an apparatus according to one or more embodiments.

FIG. 6 depicts a schematic of a diagram of consecutive positions of rollers along a wellbore with a changing diameter.

FIG. 7 depicts an example method of sampling a reservoir with enhanced accuracy.

FIG. 8 depicts an example method of monitoring an apparatus in a wellbore.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

An apparatus for measuring at least one of downhole position and velocity includes a body. The body can be an elongated body. The body can be configured to connect to a conveyance. Illustrative conveyances include wireline, slickline, coiled tubing, drillstring, or the like.

Any number of rollers can be connected with the body. The rollers can be connected to the body by arms, a centralizer, a bowspring, or the like. The rollers can be wheels or other types of rollers. The rollers can be in constant contact with the wall of the wellbore. For example, the arm can radially expand if the diameter of the wellbore increases; thereby, maintaining the rollers in contact with the wall.

The apparatus can also have a plurality of sensors connected with the body. The plurality of sensors can acquire roller data and wellbore data, and the acquired data can be used to determine at least one of the velocity and position of the apparatus.

The plurality of sensors can include one or more roller sensors. The roller sensors can be located adjacent or integrated into the rollers. The roller sensors can be any sensors that can determine the number of revolutions of the roller, the speed of the rollers, the angular position of the rollers, or combinations thereof. Illustrative roller sensors include optical encoders, electromagnetic resolvers, proximity sensors, Hall Effect sensors, tachogenerators, or the like.

The plurality of sensors can also include any number of displacement sensors. The displacement sensors can be used to determine the diameter of the wellbore. The displacement sensors can be operatively disposed on the body to monitor the expansion of the arms. For example, the displacement sensors can be connected to or adjacent a slider that moves as the arms radially expand or radially retract, and the position of the slider can be used to determine the radial position of the arms. The radial position of the arms can correlate to wellbore diameter. The displacement sensors can be any sensor or array of sensors that can monitor the position of the arms. The displacement sensors can measure linear displacement of the arms, angular displacement of the arms, or combinations thereof. Illustrative displacement sensors can include photoelectric sensors, magnetic sensors, capacitive sensors, inductive sensors, potentiometer sensors, linear variable differential transformers, or the like.

Furthermore, the plurality of sensors can include other sensors such as accelerometers, magnetometers, gyroscopes, or the like. The other sensors can acquire information related to inclination, azimuth, and general orientation of the wellbore.

The example apparatus can also include an electronic module in communication with the sensors. The electronic module can enable communication between the plurality of sensors and the surface and provide power to the sensors. In an embodiment, the electronic module can include a processor that is configured to determine the distance traveled by the apparatus, true vertical depth of the apparatus, or combinations thereof. The processor can communicate the distance traveled by the apparatus, the true vertical depth of the apparatus, or combinations thereof to downhole tools connected with the apparatus, to the surface, or both. The processor can store the distance traveled by the apparatus, the true vertical depth of the apparatus, or combinations thereof in memory. In one or more embodiments, the processor can transmit and store the distance traveled by the apparatus, the true vertical depth of the apparatus, or combinations thereof.

An example method of monitoring an apparatus in a wellbore includes acquiring roller data related to the number of revolutions of a roller connected to a body of an apparatus. The roller data can be acquired my measuring the speed, angular position, or other parameters. The method also includes acquiring wellbore data related to wellbore properties. The wellbore data includes wellbore diameter, azimuth, inclination, or the like.

The method can also include transmitting the roller data and wellbore data to a processor and determining velocity of the apparatus and position of the apparatus in the wellbore. The velocity of the apparatus can be determined by dividing the angular displacement between two consecutive measurements by the elapse time. The displacement of the apparatus can be determined by counting the number of roller revolutions and multiplying by the roller circumference, and the displacement along the wellbore axis can be found by accounting for changes in wellbore diameter. The equation ΔX=\sqrt{ΔL²−}ΔY² can be used to calculate the displacement of the apparatus along the axis of the wellbore; ΔX is the displacement along the axis of the wellbore between two consecutive roller positions; ΔL is the displacement of the rollers along the wellbore wall between two consecutive roller positions; ΔY is the change in the wellbore diameter between two consecutive roller positions. Other equations and wellbore data can be used; one skilled in the art with the aid of this disclosure would know the equations and data to use to obtain displacement of the apparatus along the wellbore axis.

In one or more embodiments, the method further includes connecting a downhole tool with the apparatus. The downhole tool can be used to acquire formation data at stations within the wellbore. The formation data can include formation pressure data, formation fluid density, or the like.

For example, the downhole tool can be configured to acquire pressure data at stations at specific locations within the wellbore. Often position measurements conducted at the surface are inaccurate, due to cable stretch, wellbore shape, or the like. Accordingly, the determined position can be used to ensure that the downhole tool is at the specific location before tests are taken so that an accurate pressure gradient can be developed using the determined position of the apparatus and the acquired pressure data.

In another example, the downhole tool can be a logging tool, and the determined position of the apparatus can be used to accurately place the acquired logging data at accurate depths. Furthermore, the determined velocity can be used to accurate velocity sensitive logging data.

Another embodiment of a method of monitoring an apparatus in a wellbore includes measuring the number of revolutions of a roller connected with an apparatus. The number of revolutions can be measured using now known techniques or future known techniques. The method can also include acquiring wellbore data related to wellbore properties. The wellbore data can be acquired using now known or future known techniques. The method also includes determining the velocity of the apparatus using the wellbore data and the measured number of revolutions.

One or more embodiments of the method can include conveying the apparatus into the wellbore with a conveyance device. The conveyance device can be a downhole tractor or the like. The method can also include comparing a desired velocity of the conveyance device with the determined velocity of the apparatus. For example, an operator at surface can set a tractor velocity at N and the determined velocity can be compared to N. If the determined velocity deviates from N, then the operator can adjust the speed of a spooling device to ensure safe conveyance of the apparatus. For example, the operator can adjust a spooling device connected to a downhole line to match the determined velocity to ensure that excess downhole line is not run downhole and that tension on the conveyance device is not too great.

One or more embodiments of a method for measuring velocity and position in a wellbore can be used to increase the accuracy of differential formation pressure measurements. The method can include measuring the distance between pressure measurement stations or locations along the wellbore using one or more rollers in contact with the wellbore walls. For example, the rollers can be equipped with sensors to measure the revolutions of the rollers. The method also includes improving the accuracy of the distance measurement by combining it with measurement of the borehole diameter. The borehole diameter can be acquired using instrumented measurement arms. The method can also include obtaining the vertical depth between the pressure measurement stations by combining the distance measurement along the borehole with inclination and azimuth measurements obtained by accelerometers, gyroscopes and magnetometers.

One or more embodiments of a method for measuring velocity and position in a wellbore can be used to improve the quality of logs by compensating for the effects of stick-slip phenomena. The method can include measuring the downhole velocity and position of the toolstring using one or more measuring rollers in contact with the formation. The method can also include recording the toolstring velocity and position for each point where another measurement is being made. The method can also include using the recorded velocity and position measurements to place other measurements in the accurate depth location in the wellbore and also to scale or otherwise accurate velocity-sensitive measurements.

One or more embodiments of a method for measuring velocity and position in a wellbore can be used to improve the accuracy of depth correlation in deviated and horizontal wells. The method can include measuring the distance from surface or another reference location along the wellbore of a toolstring using one or more measuring rollers in contact with the formation, the measuring rollers can be equipped with sensors to measure the number of revolutions. The method can also include improving the accuracy of the distance measurement by combining it with measurement of the borehole diameter. The method can also include improving the accuracy of the depth measurement by correlation with surface measurements of depth combined with surface measurements of cable tension and downhole head tension in the vertical portion of the well.

One or more embodiments of a method for measuring velocity and position in a wellbore can be used to measure the rate of penetration (ROP) of a downhole drilling or milling assembly. The method can include measuring the distance between a reference location and the location of the toolstring by using one or more measuring rollers in contact with the wellbore walls, the rollers can be equipped with sensors to measure the number of revolutions. The method can also include improving the accuracy of the distance measurement by combining it with measurements of the borehole diameter. The method can also include obtaining rate of penetration numbers by dividing the distance traveled by the time it took to travel between two positions in the well, and improving the accuracy of the rate of penetration measurements by combining the direct velocity measurements taken by the measurement rollers, non-contact accelerometer measurements, or combinations thereof.

One or more embodiments of a method for measuring velocity and position in a wellbore can be used to provide position information when conducting mechanical services in a well. The method can include measuring the distance between a reference location and the location of the toolstring by using one or more measuring rollers in contact with the wellbore walls, the rollers can be equipped with sensors to measure number of revolutions. The method can also include improving the accuracy of the distance measurement by combining it with measurement of the borehole diameter.

One or more embodiments of a method for measuring velocity and position in a wellbore can be used to provide navigational information to autonomous robotic vehicles operating in a wellbore. The method can include measuring the distance between the location of the robotic device in the well and a reference location by using measurement rollers in contact with the wellbore, the rollers equipped with sensors to measure the number of revolutions of the rollers. The method can also include measuring the velocity with which the robotic vehicle travels in the wellbore by using measuring rollers in contact with the wellbore; the rollers equipped with tachogenerators or other velocity sensors. The method can also include using the position and velocity data with measurements from non-contact devices such as accelerometers, inclinometers, magnetometers, and gyroscopes in navigation algorithms.

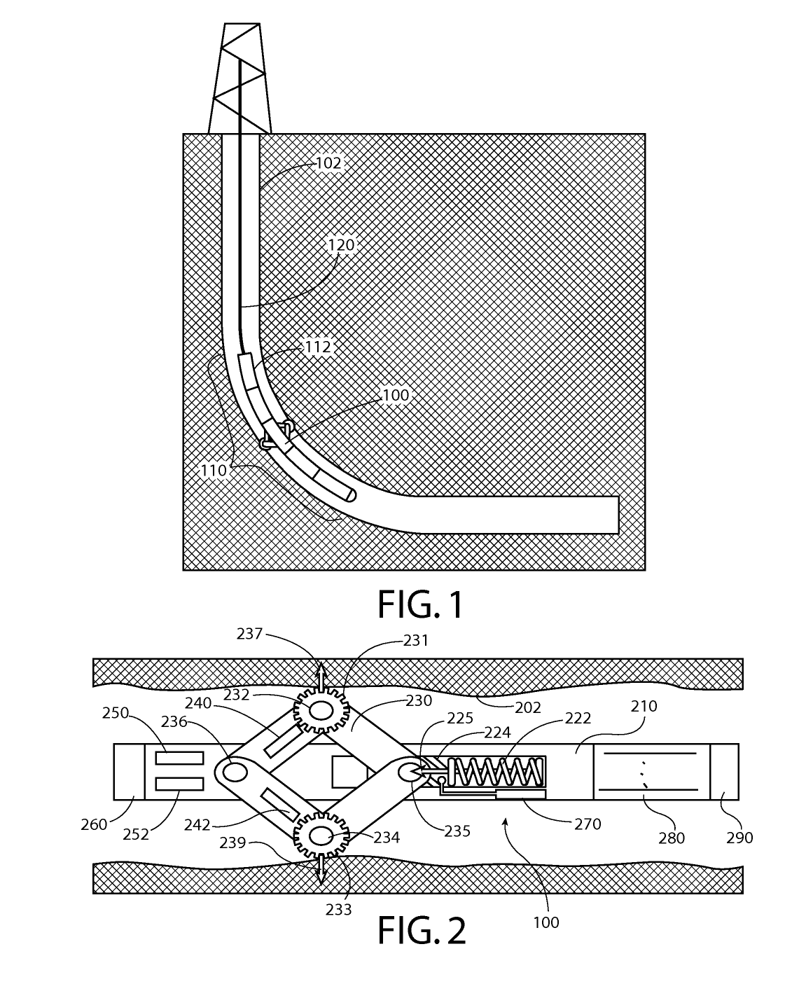

Now turning to FIG. 1, FIG. 1 depicts a schematic of an apparatus located in a wellbore. The apparatus 100 can be integrated with a tool string 110. The toolstring 110 can include any number of downhole tools 112. Illustrative downhole tools include logging tools, sampling tools, perforation tools, milling tools, or the like. The wellbore 102 can have a plurality of stations or locations where measurements are to be taken, operations performed, or both. The apparatus 100 can enable accurate placement of the toolstring 110 and can be used to determine velocity of the toolstring 110 to enable accurate velocity sensitive measurements. The apparatus 100 can also determine velocity and relay the velocity back to the surface, allowing an operator at surface to take appropriate action to enhance the safety of the conveyance.

The wellbore 102 can have one or more horizontal portions, one or more vertical portions, one or more deviated portions, or combinations thereof. The apparatus 100 can be deployed into an openhole well or a cased well. The toolstring 110 can be conveyed into the wellbore 102 using a conveyance 120. The conveyance 120 can be wireline, slickline, coiled tubing, drillstring, or the like.

FIG. 2 depicts a schematic of an apparatus according to one or more embodiments. The apparatus 100 has a body 210. The body 210 has a first end 260 and a second end 290. The first end 260, the second end 290, or both can be configured to connect to a downhole tool in a toolstring, a tractor, a conveyance, or the like.

An arm assembly 230 can include a plurality of arms. The arms can function like linkages. A first joint 235 and a second joint 236 connect the arm assembly 230 to the body 210. The first joint 235 and the second joint 236 can be rotating joints or other suitable joints. The arm assembly 230 can expand or retract radially.

A first roller 231 and a second roller 233 are located on the arm assembly 230; thereby, connecting the first roller 231 and the second roller 233 with the body 210. The first roller 231 is connected with the arm assembly 230 by a first axle 232, and the second roller 233 is connected with the arm assembly 230 by a second axle 234. The arm assembly 230 urges the first roller 231 in a first direction 237 towards a wellbore wall 202, and the arm assembly 230 urges the second roller 233 in a second direction 239 towards the wellbore wall 202.

Roller sensors 240 and 242 are operatively connected with the body 210; for example, the roller sensors 240 and 242 are located on the arm assembly 230. The roller sensors 240 and 242 are configured to measure speed, angular position, revolutions of the rollers, or combinations thereof. The roller sensors 240 and 242 can be an array of sensors or a single sensor. Accordingly, the roller sensors 240 and 242, although represented as two sensors, can include any number of sensors.

A slider 224 is connected with the arm assembly 230. The slider 224 is configured to move relative to the body 210. The slider 224 is biased in a longitudinal direction 225 by a spring 222. The slider 224 maintains the arm assembly 230 in an expanded configuration; thereby, maintaining the rollers 231 and 233 in contact with the wellbore wall 202.

A displacement sensor 270 is located on the body 210. The displacement sensor 270 is operatively located on the body 210 to measure the position of the slider 224, and the position of the slider 224 correlates to the radial expansion of the arm assembly 230; therefore, the diameter of the wellbore can be determined by the position of the slider 224. Accordingly, the displacement sensor 270 acquires wellbore data related to the diameter of the wellbore.

A first indirect sensor 250 and a second indirect sensor 252 are located on the body 210. The first indirect sensor 250 and the second indirect sensor 252 can acquire wellbore data. The wellbore data can be the azimuth, inclination, or other properties. The first indirect sensor 250 and the second indirect sensor 252 can be accelerometers, magnetometers, gyroscopes, or the like.

The wellbore data collected by the indirect sensors 250 and 252 can be used to find the true vertical depth, check the accuracy of the displacement sensor 270 and the roller sensors 240 and 242, or combinations thereof. For example, one of the indirect sensors 250 and 252 can be an accelerometer and can be used to indirectly measure the velocity and position of the apparatus 100. For example, the accelerometer can acquire data on the acceleration of the apparatus 100, and the acquired data can be integrated over a time period to determine the velocity of the apparatus. The determined velocity of the apparatus can be multiplied by time to provide the displacement of the apparatus; thereby, allowing the position of the apparatus to be indirectly determined. Accordingly, the velocity and displacement of the apparatus 100 determined from the roller data collected by the roller sensors 240 and 242 and the wellbore data collected by the displacement sensor 270 can be cross checked with the velocity of the apparatus and displacement of the apparatus derived from the data acquired by the accelerometer.

The apparatus 100 can also include an electronics module 280. The electronics module 280 can include telemetry equipment, power equipment, a processor, memory, or combinations thereof. The electronics module 280 can be configured to provide power to the sensors. The electronics module 280 can send command signals to the sensors, receive data from the signals, process the signals, enable the sensors to talk with a surface processor, or combinations thereof.

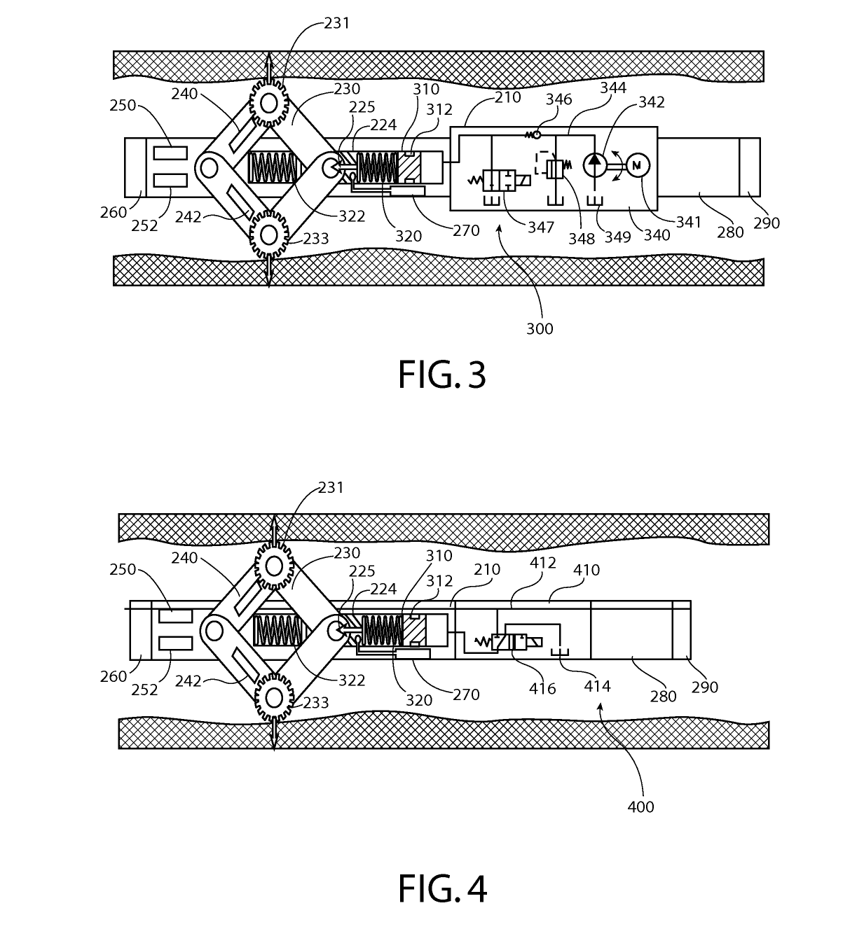

FIG. 3 depicts a schematic of an apparatus according to one or more embodiments. The apparatus 300 includes the body 210, the electronic module 280, the ends 260 and 290, the arm assembly 230, the rollers 231 and 233, the roller sensors 240 and 242, the displacement sensor 270, the slider 224, and the indirect sensors 250 and 252.

The apparatus 300 can also include a hydraulic module 340. The hydraulic module 340 can be in fluid communication with a piston 310. The piston 310 can have a seal 312 located thereabout, thereby, allowing pressure to build up behind the piston 310. The hydraulic module 340 has a motor 341. The motor 341 drives a pump 342. The pump 342 pumps fluid to move the piston 310.

The hydraulic module 340 can also include a pressure relief and safety valve 348, a check valve 346, a solenoid valve 347, and a pressure compensated oil reservoir 349. The solenoid valve 347, electric motor 341 and hydraulic pump 342 will be activated when the operator decides to deploy the arm assembly 230. The pump 342 provides pressure to the piston 310 via line 344. The pressure upon obtaining a certain value moves the piston 310, and the piston 310 moves the slider 224 in the first direction 225 urging the rollers 231 and 233 into contact with the wellbore walls. The operation of the pump 342 and the motor 341 is stopped after deployment of the arm assembly 230.

A suspension spring 320 is located between the piston 310 and the slider 224. The arm assembly retracts or extends to adapt to changing wellbore diameter, and the suspension spring 320 can absorb vibrations caused by the movement of the arm assembly 230. The suspension spring 320 can also aid in maintaining the rollers 231 and 233 in contact with the wellbore wall as the diameter of the wellbore changes.

After completion of measurements, an operator can shut the solenoid valve 347, allowing hydraulic fluid providing pressure to the piston 310 to return to the reservoir 348. A closing spring 322 forces the slider 224 to a closed position; thereby returning the arm assembly 230 to a retracted position.

FIG. 4 depicts a schematic of an apparatus according to one or more embodiments. The apparatus 400 includes the body 210, the electronic module 280, the ends 260 and 290, the arm assembly 230, the rollers 231 and 233, the roller sensors 240 and 242, the displacement sensor 270, the slider 224, the indirect sensors 250 and 252, the piston 310, the seal 312, the suspension spring 320, and the closing spring 322.

The apparatus 400 also includes a hydraulic module 410. A downhole tool (not shown) connected with the apparatus 400 can have a hydraulic system (not shown), and the hydraulic system can be in communication with the hydraulic module 410 via line 412. The hydraulic module 410 has a solenoid valve 416 and reservoir 414. The hydraulic module 410 is in fluid communication with the piston 310. The solenoid valve 416 can be opened or closed to control hydraulic pressure provided to the piston 310. The apparatus 400 can be operated in a manner similar to the apparatus 300.

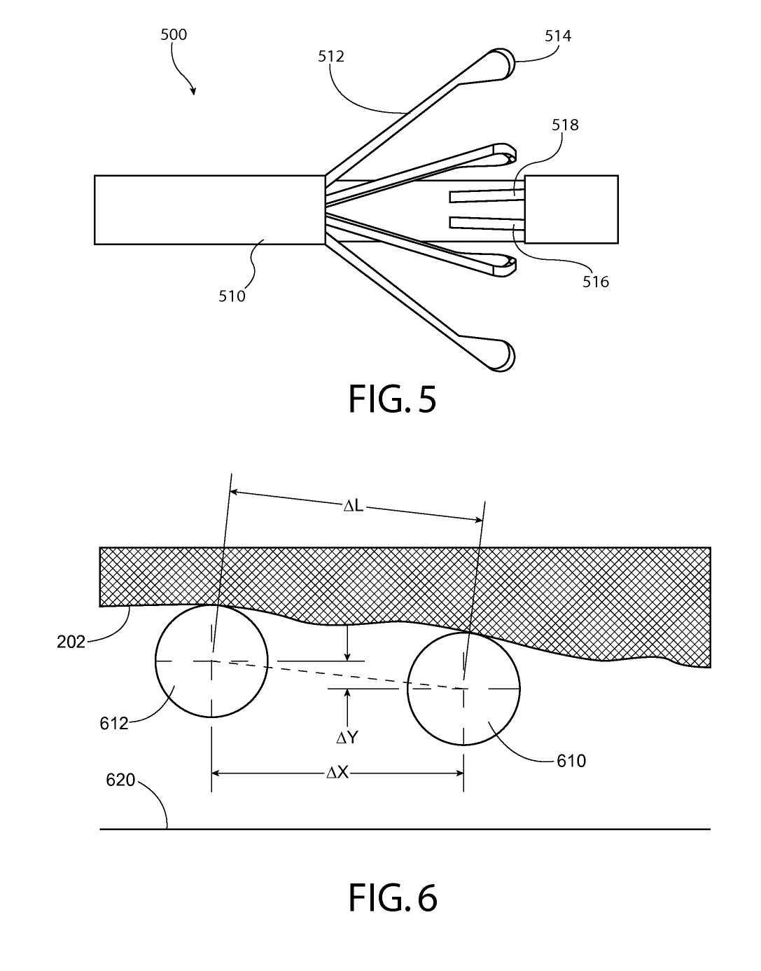

FIG. 5 depicts a schematic of an apparatus according to one or more embodiments. The apparatus 500 includes a body 510, arms 512, any number of displacement sensors 516, an accelerometer 518, and roller assemblies 514.

The roller assemblies 514 are connected with the body 510 by arms 512. The arms 512 are configured to radially expand or retract to correspond to the wellbore diameter. The displacement sensors 516 measure the displacement of the arms 516. The accelerometer 518 measures the velocity of the body 510. The roller assemblies 514 have roller sensors or devices for measuring the revolutions of the roller assemblies 514. Data acquired by the displacement sensors 516, the accelerometer 518, and the roller sensors can be sent to the surface, and a processor can use the data to calculate the velocity of the apparatus and position of the apparatus using trigonometry functions, as would be known to one skilled in the art with the aid of this disclosure.

FIG. 6 depicts a schematic of a diagram of consecutive positions of rollers along a wellbore with a changing diameter. The rollers are depicted having a first measurement position 610. The rollers move along the wellbore wall to a second measurement position 612. The rollers traveling along the wellbore wall have a measured displacement AL. The diameter of the wellbore changes from the first measurement position 610 and the second measurement position 612, the change in the wellbore diameter from the first measurement position 610 to the second measurement position 612 is represented as ΔY. ΔX is the displacement of the rollers along the axis 620 of the wellbore. LX is often needed to properly locate a tool in a wellbore. By measuring ΔL, using one or more roller sensors, and ΔY, using one or more displacement sensors, ΔX can be derived using ΔX=\sqrt{ΔL²−}ΔY²; thereby, allowing accurate placement of an apparatus in a wellbore. A processor on the apparatus, a processor at the surface, or combinations thereof can be programmed, as would be known to one skilled in the art with the aid of this disclosure, to derive ΔX using data obtained by the one or more roller sensors and one or more displacement sensors. In an example, an apparatus can be connected with a toolstring used to perform a mechanical service in a well, and the apparatus can acquire wellbore data as described herein and used to derive ΔX. Accordingly, the toolstring can be positioned at an exact position relative to a completion feature and the mechanical service can be performed. The completion feature can be a nipple, valve, landing profile, or the like.

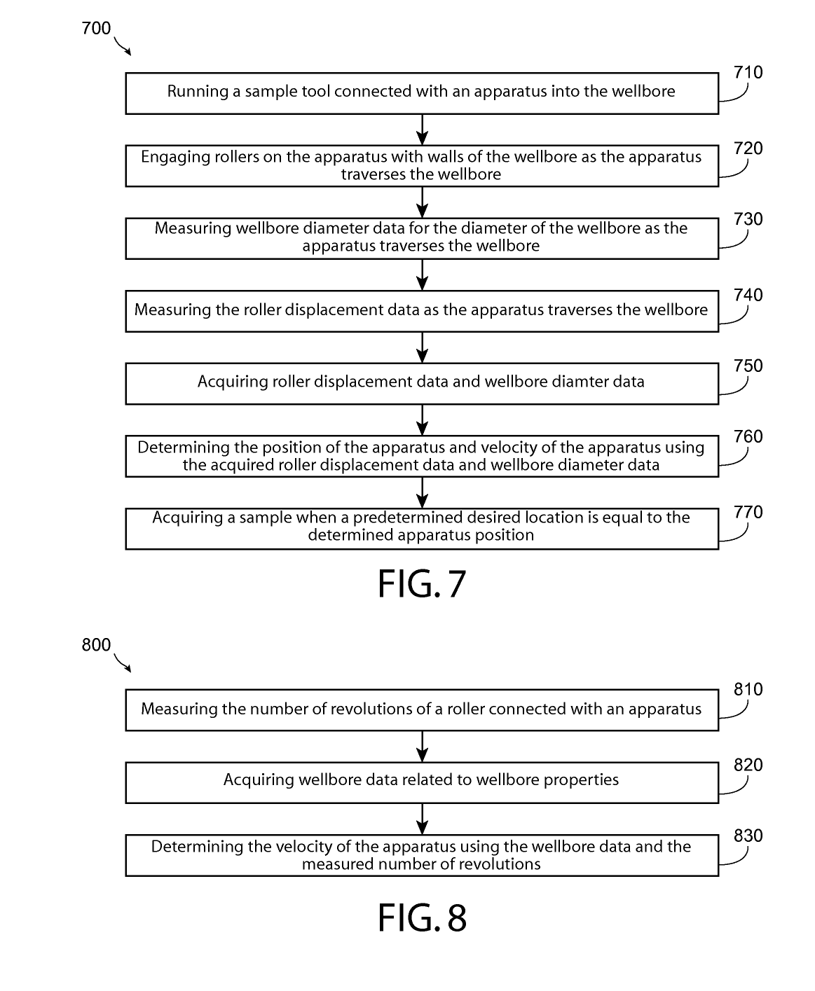

FIG. 7 depicts an example method of sampling a reservoir with enhanced accuracy. The method 700 is represented as a series of operations or blocks.

The method 700 includes running a sample tool connected with an apparatus into the wellbore (Block 710). The apparatus can be any described herein. The sampling tool can be a tool configured to take fluid samples at distinct locations along the wellbore, a logging tool configured to acquire logging data along the wellbore, or other formation sampling tools.

The method also includes engaging rollers on the apparatus with walls of the wellbore as the apparatus traverses the wellbore (Block 720). The method also includes measuring wellbore diameter data for the diameter of the wellbore as the apparatus traverses the wellbore (Block 730). The method also includes measuring the roller displacement data as the apparatus traverses the wellbore (Block 740).

The method also includes acquiring roller displacement data and wellbore diameter data (Block 750). The roller displacement data and wellbore diameter data can be acquired by sending the acquired data to a processor at the surface, a processor on the apparatus, or combinations thereof.

The method also includes determining the position of the apparatus and velocity of the apparatus using the acquired roller displacement data and wellbore diameter data (Block 760). The method also includes acquiring a sample when a predetermined desired location is equal to the determined apparatus position (Block 770).

FIG. 8 depicts an example method of monitoring an apparatus in a wellbore. The method 800 is represented as a series of operations or blocks.

The method 800 includes measuring the number of revolutions of a roller connected with an apparatus (Block 810). The method 800 also includes acquiring wellbore data related to wellbore properties (Block 820). The method can further include determining the velocity of the apparatus using the wellbore data and the measured number of revolutions (Block 830).

Although example assemblies, methods, systems have been described herein, the scope of coverage of this patent is not limited thereto. On the contrary, this patent covers every method, nozzle assembly, and article of manufacture fairly falling within the scope of the appended claims either literally or under the doctrine of equivalents.

What is claimed is:

1. An apparatus for measuring at least one of downhole position and velocity, wherein the apparatus comprises:
a body;
a roller connected with the body; and
a plurality of sensors connected with the body to acquire roller data and wellbore data, wherein the roller data and wellbore data is used to determine at least one of the velocity and position of the apparatus; and
an electronic module in communication with the plurality of sensors.

2. The apparatus of claim 1, wherein the plurality of sensors comprises a roller sensor.

3. The apparatus of claim 2, wherein the plurality of sensors further comprises a displacement sensor.

4. The apparatus of claim 3, wherein the displacement sensor is operatively connected with the body, the arm, or both to acquire data on the angle of the arm.

5. The apparatus of claim 3, wherein the plurality of sensors further comprise an accelerometer, magnetometers, gyroscopes, or combinations thereof.

6. The apparatus of claim 1, wherein the roller is located on an arm connected with the body.

7. The apparatus of claim 6, wherein a slider is engaged with the arm, and wherein the slider moves relative to the body to extend or retract the arm.

8. The apparatus of claim 7, wherein a roller sensor is located on the arm.

9. The apparatus of claim 8, wherein a displacement sensor is operatively connected with the slider, the body, or both to acquire data on the position of the slider.

10. The apparatus of claim 1, wherein the electronic module comprises a processor in communication with the plurality of sensors, and wherein the processor is configured to determine the velocity and position of the apparatus.

11. A method of monitoring an apparatus in a wellbore, wherein the method comprises:
acquiring roller data related to the number of revolutions of a roller connected to a body of the apparatus;
acquiring wellbore data related to wellbore properties;
transmitting the roller data and wellbore data to a processor; and
determining velocity of the apparatus, position of the apparatus in the wellbore, or both.

12. The method of claim 11, further comprising connecting a downhole tool with the apparatus, wherein the downhole tool is configured to acquire formation data at stations within the wellbore.

13. The method of claim 12, wherein the formation data comprises formation pressure data.

14. A method of monitoring an apparatus in a wellbore, wherein the method comprises:
measuring the number of revolutions of a roller connected with the apparatus;
acquiring wellbore data related to wellbore properties; and
determining the velocity of the apparatus using wellbore data and number of revolutions of the roller.

15. The method of claim 14, further comprising conveying the apparatus into the wellbore with a conveyance device.

16. The method of claim 15, comparing a desired velocity of the conveyance device with the determined velocity of the apparatus.

17. The method of claim 16, further comprising adjusting a spooling device connected to a downhole line to match the determined velocity.
